(19) United States
(12) Patent Application Publication
(10) Pub. No.: US 2005/0198876 A1
(43) Pub. Date: Sep. 15, 2005

(54) Assembly for mounting a monitoring device on a license plate

(76) Inventors: Tsao-fang Chang, Jhongli City (TW); Chien Mu Hou, Baoshan Township (TW); En-ta Chuang, Sinpu Township (TW); Wen Yen Wang, Dali City (TW)

Correspondence Address: J.C. Patents, 4 Venture, Suite 250, Irvine, CA, 92618, US

(21) Appl. No.: 10/799,266

(22) Filed: Mar. 11, 2004

(51) Int. Cl. G09F 7/00

(52) U.S. Cl. 40/209

(57) ABSTRACT

An assembly is provided for mounting a monitoring device on a license plate of a vehicle. The assembly comprises a frame and a fixing device. The frame comprises a hole surrounding a monitoring device. The fixing device is for fixing the frame on the license plate to position the monitoring device on and adjacent to the boundary of the license plate. The assembly may further comprise a spacer between the hole and the rear of the vehicle.

### BACKGROUND

1. Field of Invention

The present invention relates to a frame on a license plate of a vehicle. More particularly, the present invention relates to an assembly for mounting a monitoring device on a license plate of a vehicle.

2. Description of Related Art

It is desirable to provide a driver of a vehicle with some information associated with, representing, or describing a portion of the area surrounding the vehicle or the environment in which the vehicle is disposed within, thereby identifying potential threats, objects, or hazards to the driver and significantly improving the driver's ability to avoid an accident or other misfortune.

Some efforts have been previously made to improve the driver's awareness or knowledge of the vehicle's environment. Conventionally, these prior efforts include providing and selectively installing devices such as mirrors, lights, or windows upon the vehicle, in order to improve the driver's range of vision. These devices and/or assemblies provide the driver with information concerning only a rather limited portion of the vehicle environment and often include a number of undesirable “blind spots” or areas for which no information or image is provided.

Another method or technique of increasing the driver's awareness or knowledge of the area proximate to the vehicle requires the installation of a sensor system upon and/or within the vehicle. Particularly, the sensor system provides certain information to the driver and warns the driver if the vehicle is close to colliding an object. The sensor system may comprise a monitoring device installed on the bumper bar at the rear of the vehicle. Being installed in this way, the monitoring device is easily damaged by collision.

### SUMMARY

An assembly is provided for mounting a monitoring device on a license plate and a rear of a vehicle, wherein the license plate has a boundary and two first holes, and wherein the first holes has a first distance therebetween. The assembly comprises a frame, two extending pieces and two bolts. The frame has a shape substantially the same as the boundary of the license plate, wherein the frame has a second hole surrounding the monitoring device. The extending pieces respectively have third holes, wherein the third holes have a second distance therebetween, and wherein the second distance is substantially the same as the first distance between the first holes of the license plate. The bolts are for fixing the frame on the license plate through the third holes and the first holes.

Preferably, the frame has a shape of a rectangular or a bar. Moreover, the assembly further comprise a first piece, a second piece and third piece, wherein the first piece touches the rear of the vehicle, the second piece is between the frame and the first piece, and the third piece is between the first and the second pieces. In addition, the assembly further comprise a cap on the second hole.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

In the drawings,

FIG. 1 is a graphic drawing of the invention herein in an actual implement.

FIG. 2 is a front view of an assembly for mounting a monitoring device on and adjacent to the boundary of a license plate according to the present invention.

FIG. 3 shows a schematically three-dimensional structure of the assembly according to the present invention.

FIG. 4 is a front view of an assembly having a shape of a bar according to the present invention.

FIG. 5D is schematically three-dimensional view of an assembly and a license plate according to the present invention.

FIG. 5A-5D is a process flowchart illustrating a method of using the assembly according to the present invention.

FIG. 6 is a schematically side view of an assembly according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### EXAMPLE I

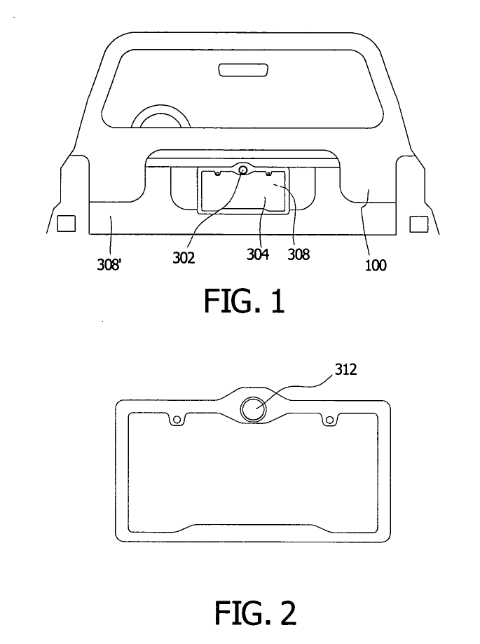

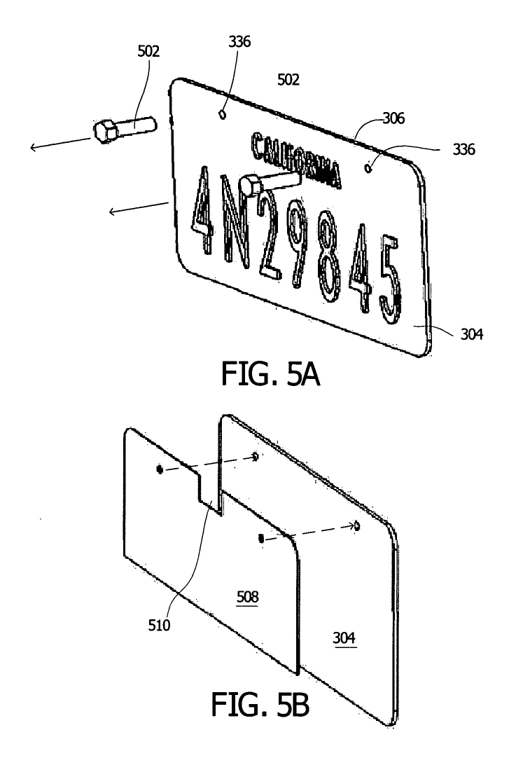

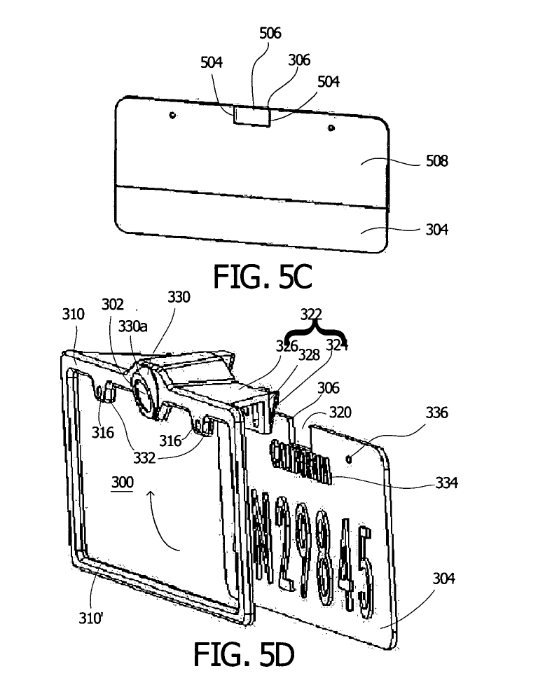

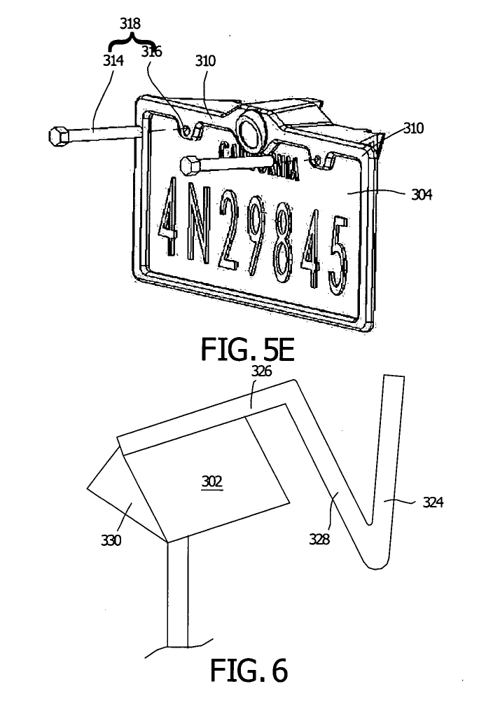

FIG. 5D is schematically three-dimensional view of an assembly and a license plate according to the present invention. Referring to FIG. 5D, the assembly 300 for mounting a monitoring device 302 on and adjacent to the boundary 306 of the license plate 304 for a vehicle 100 (FIG. 1). The monitoring device 302 helps a vehicle driver to know if the rear 308′ (FIG. 1) of the vehicle 100 will collide solid objects during the vehicle 100 is reversed. The viewing angle of the monitoring device 330 (FIG. 5D) is, for example, about 150 degrees in a horizontal plane and about 90 degrees in a vertical plane. Other exemplary parameters of the monitoring device 330 are as follow:

| Items | Parameters |
|---|---|
| Number of effective pixels | NTSC: 512(H) * 492(V); PAL: |
| | 512(H) * 582(V) |
| Sensor | ⅓ inch - type CCD. Sensor Dia: 150 |
| | (1.5 mm), Hor: 115.8, Ver: 86.2 |
| Resolution/Digitalis | >250,000 pixels/10 bit A/D Converter |
| Minimum illumination | 1.0 LUX/F1.2 |
| S/N ratio | More than 48 dB |
| Exposure | A.E: auto electronics shutter 1/60 s |
| | (1/50 s) − 1/100000 s |
| Video output | 1.0 Vₚ - p composite video. 75(OHM) load |
| Power consumption | 180 mA, 2.4 W(max) |
| Operation temp/Storage temp | −30° C. to 80° C./−40° C. to 85° C. |
| Supply voltage | DC 12 V, 180 mA(+/−10%) |
| Horizontal/Vertical A Angle | Minimum 104° + −2°/Minimum |
| | 80° + −2° |

According to the present invention, the assembly 300 comprises, for example, a frame 310 having a circular hole 312 (FIG. 2) suitable for installing the monitoring device 330 (FIG. 5D). The front portion of the monitoring device 302 may have a lens exposed by the circular hole 312 (FIG. 2). This frame 310 is called, for example, i-CAM, Template, Camplate, Cam-in-Frame or CARCam-in-Frame. The “i” of i-CAM substantially means “in”, “including”, “involving” or “installing”.

The frame 310 has a shape of, for example, a rectangular 310′ which size is substantially the same as the boundary 306 of the license plate 304. More specifically, the rectangular frame 310 may have a size of about, for example, 380×170 mm, and have a width of about, for example, 10-20 mm, and preferably about 15 mm. The width of the rectangular frame 310 is preferably smaller than 40 mm, thereby ensuring that no word or sticker on the license plate is shielded by the frame 310 when the frame 310 is aligned with the license plate 304. The word is, for example, the name of a state in U.S. (e.g., CALIFORNIA; reference number 334). The sticker is, for example, a proof of completing tax payment or exhaust examination. The proof is conventionally stuck on the sides of the word 334, which word is often printed on the upper portion of the license plate 304.

The upper portion of the frame 310 may have a circular hole 312 (FIG. 2) suitable for positioning the front portion of the monitoring device 302. In a plane vertical to the ground and to the rear 308 (FIG. 1) of a vehicle 100, the angle between the monitoring central line and a horizontal line is ranging from, for example, about 0-70 degrees. The angle, more preferable, is about 0-60 degrees. The most preferable angle is, for example, about 45 degrees. In such an angle, the monitoring device 302 (FIG. 5D) detects solid objects near the rear 308 (FIG. 1) of the vehicle 100 during the vehicle 100 is reversed.

The monitoring device 302 (FIG. 5D) is, for example, connected to an image displaying mechanism or an alarming mechanism for notifying the driver that the vehicle 100 (FIG. 1) is almost colliding solid objects near the rear 308′ of the vehicle 100, and therefore preventing the vehicle 100 from colliding the solid objects. The mechanism may accept signals from the monitoring device 302 in, for example, a wireless way.

Note that the preferable angle depends on the positioning way of the license plate 304. Before using the present invention, some license plates are positioned in a direction not substantially vertical to the ground, and some license plates are imbedded into the rears of the vehicles. For those license plates, the preferable angle can be amended to clearly monitor solid objects near the rear of the car.

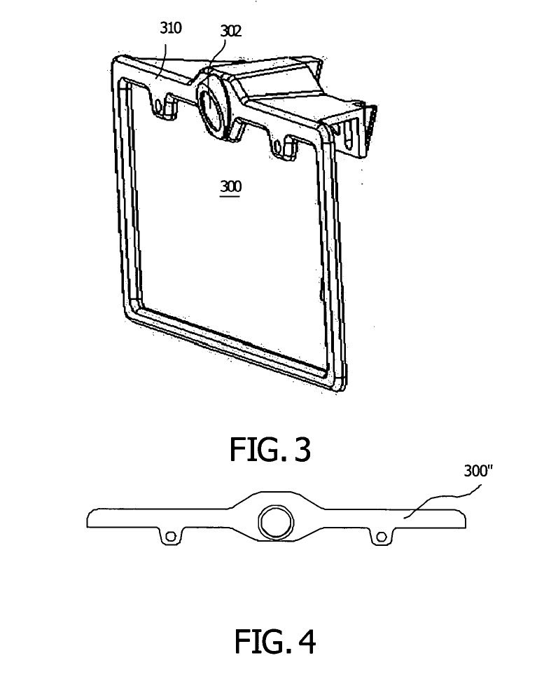

Each of the license plates imbedded into the rear of a vehicle often have a lower boundary almost touching the body of the vehicle. In other words, the space between the body and the license plate is sometimes not enough to accept lower portion of the frame. Because of the space consideration, the frame, as shown in FIG. 3, can alternatively have a shape of a bar having no lower portion of the rectangular frame 310′ (FIG. 5D), thereby facilitating a user to fix the frame 300″ (FIG. 4) on the license plate 304 (FIG. 5D). The bar-shaped frame 300″ may have a size of about, for example, 380×40 mm. This bar-shaped frame 300″ is called, for example, i-CAM, Template, Camplate, Cam-in-Bar or CARCam-in-Bar. The “i” of i-CAM substantially means “in”, “including”, “involving” or “installing”.

Referring to FIG. 5D, the monitoring device 302 may comprise a sensor and comprises no motherboard, wherein the motherboard being connected to the sensor is installed into the vehicle 100 (FIG. 1). The motherboard is connected to the sensor through, for example, a signal line.

Referring to FIG. 5D, the assembly 300 may comprise a first piece 324. The first piece 324, connecting to the frame 310, is designed to touch the rear 308 (FIG. 1) of the vehicle 100. The assembly 300 (FIG. 5D) may further comprise a second piece 326 connecting to the frame 310 and being located between the frame 310 and the first piece 324. By locating the second piece 324 in this way, the monitoring device 302 can be positioned substantially into the assembly 300. The monitoring device 302 has a shape of, for example, a circular cylinder. The cylinder-shaped monitoring device 302 has a length of about, for example, 1-80 mm, and preferably about 40 mm. Corresponding to the monitoring device 302, the second piece 326 has a length of about, for example, 1-80 mm, and preferably about 40 mm.

Still referring FIG. 5D, the first and second pieces 326, 324 are connected through, for example, a third piece 328 located between the two pieces 326, 324. The three pieces 324, 326, 328, can be simultaneously formed by a molding technology, increases the distance between the frame 310 and the rear 308 (FIG. 1) of the vehicle 100 and increases the strength of the assembly 300. By increasing the distance between the frame 310 (FIG. 5D) and the rear of the vehicle, the angle between the monitoring central line and the horizontal line can be adjusted to be a predetermined value.

Referring to FIG. 5D, the frame 310 can be fixed on the license plate 304 by adhering them to each other. Alternatively, the assembly 300 may further have two bolts 314 (FIG. 5E). The bolts 314, through two tap holes 316 of the frame 310, are for a user to fix the frame 310 on the license plate 304. The distance between the tap holes 316 is substantially the same as the distance between the holes 336 (FIG. 5D) of the license plate 304, wherein the holes 336 of the license plate 304 are for fixing the license plate 304 on the rear of the vehicle. Between the holes 336 of the license plate 304, the name of a state 334 is conventionally printed on the license plate 304. To prevent from shielding the name of the state 334, the frame 310 may further comprise two extending pieces 332 for forming the tap holes 316. The extending pieces 332 are connected to the upper portion of the frame 310, and can be formed simultaneously with the formation of the first, second and third pieces 324, 326, 328 by a molding technology. The extending pieces 332, the first, second and third pieces 324, 326, 328 and the frame 310 can be formed of, for example, metal. The metal can be aluminum. Alternatively, they can be formed of plastic coated with metal. The plastic is, for example, ABS plastic. The coating metal is, for example, chromium.

In addition to the extending pieces 332, a cap 330 can be formed on the circular hole of the frame. The cap, covering the front portion of the monitoring device 302, has a front boundary 330a substantially downward and thereby contributing to the above-mentioned preferable angle. In other words, the cylinder-shaped monitoring device 302 is commonly fixed by the inner surface of the cap 330 and the circular hole 312 (FIG. 2) of the frame 310. For installation of the cylinder-shaped monitoring device 302, the third piece 328 may have an opening close to the rear portion of the installed monitoring device 302.

The frame 310, the pieces 324, 326, 328 connecting to the frame 310, and the monitoring device 302 having a length of about 40 mm have a total weight of about 320 g. If the frame 310 is alternatively to be a bar-shaped frame (FIG. 4), the total weight would be about 310 g.

Corresponding to the distance between the frame 310 and the rear 308 (FIG. 1) of the vehicle 100, the top of the license plate 304 is also departed from the rear 308 of the vehicle 100 in a small distance. The small distance is about, for example, 5-80 mm, and is about 40 mm preferably. Corresponding to the small distance, each of the bolts 314 (FIG. 5E) has a length of about, for example, 50 mm.

FIG. 5A-5D is a process flowchart illustrating a method of using the assembly according to the present invention. Referring to FIG. 5A, for subsequent mounting steps of the frame 310 (FIG. 5D) on the license plate 304, the user may loosen the bolts 502 (FIG. 5A) originally fixed on the license plate 304. After the bolts 502 are loosened, the user can take off the license plate 304 from the vehicle and then form a gap 320 (FIG. 5D) adjacent to the boundary 306 (FIG. 5A) of the license plate 304. The top of the gap 320 (FIG. 5D) is preferably wider than the bottom of the gap 320, thereby easily accepting the monitoring device 302. The gap 320 is formed by, for example, cutting the license plate 304 (FIG. 5C) to form two small slits 504 adjacent to the boundary 306 of the license plate 304, and folding the portion 506 of the license plate 304 between the slits 504 back and down to hide the folded portion 506 on the rear of the license plate 304. A paper plate 508 (FIG. 5B) may be provided for the user to cover the license plate 304 before it is cut. The paper plate 508 may have a gap 510 and a shape substantially the same as the shape of the upper portion of the license plate 304. After aligning the paper plate 508 with the upper portion of the license plate 304, the user can cut the license plate 304 along the two sides of the gap 510 on the paper plate 508, thereby forming the desired slits 504 (FIG. 5C) of the license plate 304.

Returning to FIG. 5D, the gap 320 adjacent to the boundary 306 of the license plate 304 has, for example, a depth enough to partially accept the monitoring device 302. After positioning the front side of the license 304 on the backside of the frame 310, the user may align the holes 336 of the license plate 304, the tap holes 316 of the frame 310 and the holes on the rear of the vehicle with each other, and then tighten another two longer bolts 314 (FIG. 5E) to fix the frame 310 on the license plate 304 and the rear of the vehicle. The longer bolts 314 are also the above-mentioned bolts of the assembly.

### EXAMPLE II

Referring to FIG. 5D, an assembly 300 is provided for mounting a monitoring device 302 on a license plate 304 of a vehicle 100 (FIG. 1), wherein the license plate 304 has a boundary 306, and wherein the vehicle 100 (FIG. 1) has a rear 308. The assembly 300 (FIG. 5D) comprises a frame 310 having a first hole 312 (FIG. 2) surrounding the monitoring device 302 (FIG. 5D). The assembly 300 may further comprise a device 318 (FIG. 5E) for fixing the frame 300 (FIG. 5D) on the license plate 304 to position the monitoring device 302 on and adjacent to the boundary 306 of the license plate 304. The monitoring device 302 is adjacent to the boundary 306 by, for example, cutting the license plate 304 to form a gap 320 on the boundary 360 of the license plate 304 before fixing the frame 310 thereon. After the frame 310 is fixed on the license plate 304, the monitoring device 302 is positioned, for example, in the gap 320 of the license plate 304.

Preferably, the assembly 300 comprises a spacer 322 between the first hole 312 (FIG. 2) and the rear 308 (FIG. 1) of the vehicle 100. The spacer 322 (FIG. 5D) comprises a first piece 324 touching the rear 308 (FIG. 1) of the license plate 304 (FIG. 5D), a second piece 326 between the frame 310 and the first piece 324, and a third piece 328 between the first and the second pieces 326, 324. More preferably, the assembly 300 further comprise a cap 330 on the first hole 312 (FIG. 2). Moreover, the assembly 300 (FIG. 5D) further comprise two extending pieces 332 connected to the frame 310, wherein the extending pieces 332 respectively have tap holes 316. In addition, the device 318 (FIG. 5D) may comprise two bolts 314 for fixing the frame 300 (FIG. 5D) on the license plate 304 through the tap holes 316. The frame 310, the first, second and third pieces 328, 326, 324 and the extending pieces 332 can be made of the same material by a molding technology.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the spacer of the invented assembly is not limited to be between the first hole and the “rear” of the vehicle. The spacer may alternatively be between the first hole and the “front” of the vehicle where another license plate may be mounted thereon.

1. An assembly for mounting a monitoring device on a license plate and a rear of a vehicle, wherein the license plate has a boundary and two first holes, and wherein the first holes has a first distance therebetween, the assembly comprising:
a frame having a shape substantially the same as the boundary of the license plate, wherein the frame has a second hole surrounding the monitoring device;
two extending pieces respectively having third holes, wherein the third holes have a second distance therebetween, and wherein the second distance is substantially the same as the first distance between the first holes of the license plate; and
two bolts for fixing the frame on the license plate through the third holes and the first holes.

2. The assembly as recited in claim 1, wherein the frame has a shape of a rectangular.

3. The assembly as recited in claim 1, wherein the frame has a shape of a bar.

4. The assembly as recited in claim 2, further comprising a first piece touching the rear of the vehicle.

5. The assembly as recited in claim 4, further comprising a second piece between the frame and the first piece.

6. The assembly as recited in claim 5, further comprising a third piece between the first and the second pieces.

7. The assembly as recited in claim 1, further comprising a cap on the second hole.

8. The assembly as recited in claim 1, wherein the frame is made of plastic coated with metal.

9. An assembly for mounting a monitoring device on a license plate of a vehicle, wherein the license plate has a boundary, the assembly comprising:
a frame having a first hole surrounding the monitoring device;
a device for fixing the frame on the license plate, thereby positioning the monitoring device on and adjacent to the boundary of the license plate; and
a spacer between the first hole and the vehicle.

10. The assembly as recited in claim 9, wherein the spacer comprises a first piece touching the vehicle.

11. The assembly as recited in claim 10, wherein the spacer comprises a second piece between the frame and the first piece.

12. The assembly as recited in claim 11, wherein the spacer comprises a third piece between the first and the second pieces.

13. The assembly as recited in claim 12, further comprising a cap on the first hole.

14. The assembly as recited in claim 13, further comprising two extending pieces connected to the frame, wherein the extending pieces respectively have a tap hole.

15. The assembly as recited in claim 14, wherein the device comprises two bolts for fixing the frame on the license plate through the tap holes.

16. The assembly as recited in claim 15, wherein the frame, the first, second and third pieces and the extending pieces are made of the same material by a molding technology.

17. An assembly for mounting a monitoring device on a license plate of a vehicle, wherein the license plate has a boundary and a gap thereon, and wherein the vehicle has a rear, the assembly comprising:
a frame having a first hole surrounding the monitoring device;
a device for fixing the frame on the license plate to position the monitoring device in the gap of the license plate; and
a spacer between the first hole and the rear of the vehicle.
